(19) United States
(12) Patent Application Publication
(10) Pub. No.: US 2002/0180355 A1
(43) Pub. Date: Dec. 5, 2002

(54) Plasma display device

(76) Inventors: Hiroshi Mori, Kanagawa (JP); Ichiro Utsumi, Tokyo (JP); Kazunao Oniki, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/145,098

(22) Filed: May 15, 2002

(30) Foreign Application Priority Data
May 28, 2001 (JP) P2001-159042

(51) Int. Cl. H01J 17/49

(52) U.S. Cl. 313/582

(57) ABSTRACT

Disclosed is a plasma display device which is characterized in that a discharge gas sealed in plasma discharge spaces where discharge is performed is substantially only nitrogen. The discharge gas sealed in the plasma discharge spaces where the discharge is performed may include a first gas comprised of nitrogen gas, and a second gas containing at least one gas selected from the group consisting of xenon gas, krypton gas, neon gas, helium gas and argon gas. As a result, it is possible to provide a plasma display device which is high in reliability, can achieve high contrast, and can give a high luminance even at a low discharge gas pressure.

### BACKGROUND OF THE INVENTION

The present invention relates to a plasma display device, particularly to an alternating current driving type plasma display device, having a characteristic feature as to a discharge gas sealed in a discharge space where discharge is performed.

A variety of planar type (flat panel type) display devices have been investigated as an alternative to the conventional cathode ray tube (CRT) which is a main stream at present. As examples of such a planar type display device, there may be mentioned liquid crystal display devices (LCD), electroluminescence display devices (ELD) and plasma display devices (PDP). Among others, the plasma display device has the merits that it is comparatively easy to increase the screen area and the angle of visibility, the resistance to environmental factors such as temperature, magnetism and vibration is high, the useful life is long, and so on. Thus, the plasma display device is expected to be applied to a wall-hung television set for home use as well as a large-type information terminal apparatus for public use.

The plasma display device is a display device in which a voltage is impressed on discharge cells containing a discharge gas consisting of a rare gas sealed in discharge spaces, and light emission is effected by exciting a phosphor layer in the discharge cells by ultraviolet rays generated by glow discharge in the discharge gas. Namely, the individual discharge cells are driven by a principle similar to that of fluorescent lamps, and, generally, hundreds of thousands of the discharge cells are aggregated to form one display screen. The plasma display devices are generally classified into the direct current driving type (DC type) and the alternating current driving type (AC type) according to the system of impressing a voltage on the discharge cells, and both types have respective merits and demerits.

The AC type plasma display device may have a structure in which partition walls playing the role of partitioning the individual discharge cells in the display screen are formed, for example, in the shape of stripes, which is suitable for enhancing definition. Moreover, since the surfaces of electrodes for discharge are covered with a dielectric layer, the electrodes would be worn with difficulty, and a long useful life is ensured.

Generally, the discharge gas sealed in the discharge spaces is a mixture gas of an inert gas such as neon (Ne) gas, helium (He) gas or argon (Ar) gas with about 4 vol % of xenon (Xe) gas. The total pressure of the mixture gas is about 6×10⁴ to 7×10⁴ Pa, and the partial pressure of the xenon (Xe) gas is about 3×10³ Pa.

However, in the AC type plasma display devices currently commercialized, there is the problem that luminance is low. For example, the luminance of a 42-inch AC type plasma display device is no more than about 500 cd/m². Besides, in actually commercializing an AC type plasma display device, it is necessary to laminate a sheet or film for shielding electromagnetic waves or preventing reflection of external light onto the outside surface of a display-side first panel, so that the actual display light of the AC type plasma display device is quite dark. If the pressure of the discharge gas sealed in the discharge spaces is raised in order to enhance the luminance, there arise the problems that the discharge voltage is raised, the discharge becomes unstable, or the discharge becomes nonuniform.

In addition, when the pressure of the discharge gas sealed in the discharge spaces is raised, forces in the directions for separating the display-side first panel and a back-side second panel away from each other are exerted due to the pressure of the discharge gas, resulting in that the reliability of adhesion of the panels by frit glass might be lowered Besides, the discharge gas might expand due to the temperature applied to the plasma discharge device, and the discharge gas might leak out through the joint portions between the panels. Therefore, in the conventional AC type plasma display device, it has been difficult to raise the pressure of the discharge gas sealed in the discharge spaces in order to enhance the luminance.

In addition to the problem to be solved of enhancing the luminance, there is the problem of enhancing contrast. It is known that a visible light component upon light emission from the discharge gas leads to a lowering in the contrast on the panel. Particularly, in the case where neon (Ne) gas is used as the discharge gas, the visible light component upon light emission from the neon gas is orange in color, and when the concentration of the neon gas is high, the image display on the plasma display device will have a tone centralized in orange color, leading to that the contrast is lowered.

### SUMMARY OF THE INVENTION

It is an object of the present invention to provide a plasma display device which has high reliability, is capable of achieving a high contrast, and makes it possible to obtain high luminance even at a low discharge gas pressure.

In order to attain the above object, a plasma display device according to a first aspect of the present invention is characterized in that the discharge gas sealed in plasma discharge spaces where discharge is performed is substantially only nitrogen (N₂). In the present invention, the expression “substantially only nitrogen” means that the discharge gas ideally consists of 100 vol % of nitrogen, but may contain impurity gases to an extent of not affecting the effect of the present invention. For example, the discharge gas may contain other kinds of gases such as hydrogen (H₂) in an amount of not more than 1 vol %. The pressure of the discharge gas may be so set that the reliability of the alternating current driving type plasma display device is not impaired by the pressure of the discharge gas.

A plasma display device according to a second aspect of the present invention is characterized in that the discharge gas sealed in plasma discharge spaces where discharge is performed includes a first gas consisting of nitrogen gas and a second gas including at least one gas selected from the group consisting of xenon gas, krypton gas, neon gas, helium gas and argon gas. The second gas is preferably xenon gas.

According to the second aspect of the present invention, the second gas preferably includes at least two gases selected from the group consisting of xenon gas, krypton gas, neon gas, helium gas and argon gas. More preferably, the second gas includes xenon gas as an essential component and at least one gas selected from the group consisting of krypton gas, neon gas, helium gas and argon gas.

In the second aspect of the present invention, the volume ratio of the first gas and the second gas in the discharge gas is essentially arbitrary. In addition, the mixture gas constituting the discharge gas may contain other gases such as hydrogen (H₂) in an amount of, for example, not more than 1 vol %.

Further, the upper limit of the partial pressure of the first gas is not particularly specified, and may be, for example, not more than 2×10⁵ Pa, preferably not more than 1×10⁵ Pa, from the viewpoint of reliability of the plasma display device, but this is not limitative. It is desirable that the total pressure of the mixture gas is not more than 2×10⁵ Pa, preferably not more than 1×10⁵ Pa, but this is not limitative. The total pressure of the discharge gas is determined from the viewpoints of discharge voltage and panel strength.

A plasma display device according to a third aspect of the present invention is characterized in that the discharge gas sealed in plasma discharge spaces where discharge is performed includes a gas having a peak of emission spectrum intensity in a wavelength region of 200 to 400 nm, preferably 300 to 400 nm.

In the first to third aspects of the present invention, it is preferable that a phosphor layer which emits light upon receiving ultraviolet radiation in a wavelength region of 200 to 400 nm is provided in the plasma discharge spaces.

The plasma discharge device according to the first to third aspects of the present invention is preferably an alternating current driving type plasma display device including at least a pair of discharge-sustaining electrodes.

In addition to the discharge-sustaining electrodes, a bus electrode formed of a material lower in electrical resistivity than the discharge-sustaining electrodes may be provided in contact with the discharge-sustaining electrodes, in order to lower the impedance of the discharge-sustaining electrodes as a whole.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a major part exploded perspective sectional view of a plasma display device according to one embodiment of the present invention;

FIG. 2 is a graph showing the relationship between N₂ gas pressure and discharge voltage in an example of the present invention;

FIG. 3 is a general view of an emission spectrum intensity measuring instrument used in the example of the present invention;

FIG. 4 is a graph showing the emission spectrum in the case where N₂ gas is sealed in discharge spaces at 10 kPa;

FIG. 5 is a graph showing the emission spectrum in the case where an N₂—Xe mixture gas (Xe: 20 vol %) is sealed in discharge spaces at 10 kPa;

FIG. 6 is a graph showing the emission spectrum of an Ne—Xe mixture gas; and

FIG. 7 is a graph in which emission spectrum of Ne—Xe and emission spectrum of N₂ are combined into the same graph.

### DETAILED DESCRIPTION OF THE PREFERRED EMBODIMENTS

[First Embodiment]

The present invention will be described below based on the embodiments shown in the drawings.

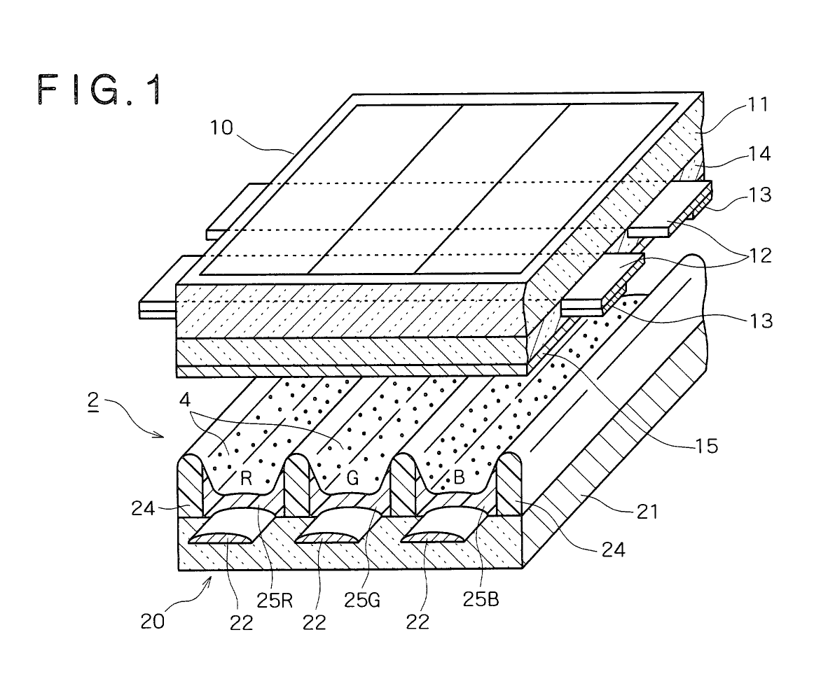

First, the total constitution of an alternating current driving type (AC type) plasma display device (hereinafter referred to simply as “plasma display device” in some cases) will be described, based on FIG. 1.

The AC type plasma display device 2 shown in FIG. 1 belongs to the so-called three-electrode type, in which discharge is generated between a pair of discharge-sustaining electrodes 12. The AC type plasma display device 2 includes a first panel 10 corresponding to front panel, and a second panel 20 corresponding to rear panel, which are adhered to each other. Light emission from phosphor layers 25R, 25G and 25B on the second panel 20 is observed, for example, through the first panel 10. Namely, the first panel 10 is on the display side.

The first panel 10 includes a transparent first substrate 11, a plurality of pairs of discharge-sustaining electrodes 12 provided in a stripe pattern on the first substrate 11 and formed of a transparent conductive material, a bus electrode 13 provided for lowering the impedance of the discharge-sustaining electrodes 12 and formed of a material lower in electrical resistivity than the discharge-sustaining electrodes 12, a dielectric layer 14 provided on the upper side of the first substrate 11 inclusive of the upper side of the bus electrode 13 and the discharge-sustaining electrodes 12, and a protective layer 15 provided on the dielectric layer 14. The protective layer 15 need not necessarily be provided, but is preferably provided.

The second panel 20 includes a second substrate 21, a plurality of address electrodes (also called “data electrodes”) 22 provided in a stripe pattern on the second substrate 21, a dielectric film (omitted in the figure) provided on the upper side of the second substrate 21 inclusive of the upper side of the address electrodes 22, insulating partition walls 24 extending in parallel with the address electrodes 22 in the regions between the adjacent address electrodes 22 on the dielectric film, and a phosphor layer provided ranging on the dielectric film and on side walls of the partition walls 24. The phosphor layer includes red phosphor layers 25R, green phosphor layers 25G, and blue phosphor layers 25B.

FIG. 1 is a partly exploded perspective view of the display device, and, actually, top portions of the partition walls 24 on the side of the second panel 20 are in contact with the protective layer 15 on the side of the first panel 10. The region where one pair of the discharge-sustaining electrodes 12 and the address electrode 22 located between two partition walls 24 overlap with each other corresponds to a single discharge cell. A discharge gas is sealed in each discharge space 4 surrounded by the adjacent partition walls 24, the phosphor layers 25R, 25G, 25B and the protective layer 15. The first panel 10 and the second panel 20 are adhered to each other at their peripheral portions by use of frit glass.

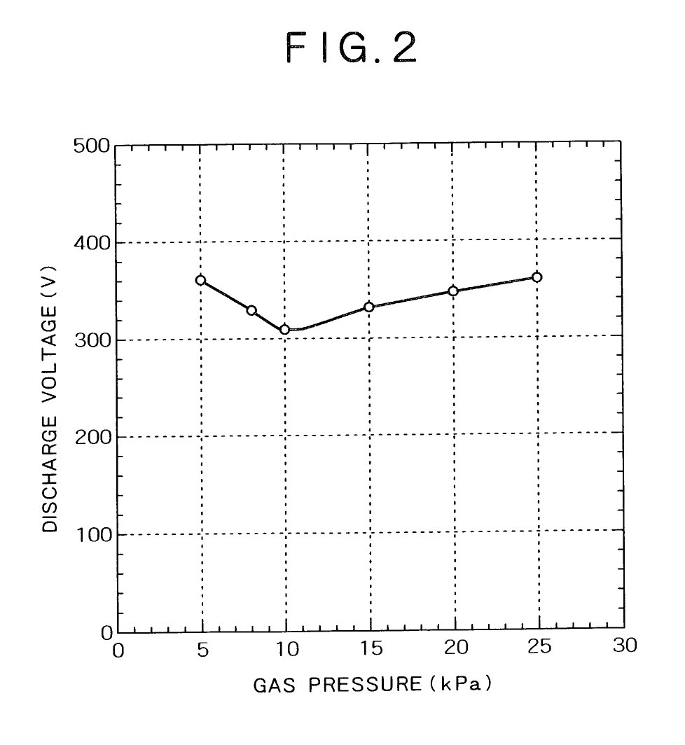

In the present embodiment, a discharge gas consisting of N₂ gas having a purity of substantially 100% is sealed in the discharge spaces 4. The sealed-in pressure (gas pressure) of the discharge gas consisting of the N₂ gas is preferably 5 to 25 kPa, more preferably 8 to 15 kPa. The gas pressure of the N₂ gas and the discharge voltage are in the relationship shown in FIG. 2, and the discharge voltage can be lowered, in the above-mentioned range.

The direction in which the projection images of the discharge-sustaining electrodes 12 extend and the direction in which the projection images of the address electrodes 22 extend are substantially orthogonal (though not necessarily orthogonal) to each other, and the region where one pair of the discharge-sustaining electrodes 12 and one set of the phosphor layers 25R, 25G, 25B for emitting light in three primary colors overlap with each other corresponds to one pixel. Since glow discharge is generated between one pair of the discharge-sustaining electrodes 12, this type of plasma display device is referred to as “plane discharge type”. By impressing, for example, a panel voltage lower than a discharge start voltage for the discharge cell on the address electrode 22 immediately before impressing a voltage between one pair of the discharge-sustaining electrodes 12, wall charges are accumulated in the discharge cell (selection of the discharge cell for display), and an apparent discharge start voltage is lowered. Subsequently, the discharge started between one pair of the discharge-sustaining electrodes 12 can be sustained at a voltage lower than the discharge start voltage. In the discharge cell, the phosphor layer excited by irradiation with vacuum ultraviolet rays generated by the glow discharge in the discharge gas gives an intrinsic light emission color according to the kind of the material of the phosphor layer. It should be noted that the vacuum ultraviolet rays having a wavelength according to the kind of the sealed discharge gas are generated.

The plasma display device 2 according to the present embodiment is a so-called reflection type plasma display device, and the light emission from the phosphor layers 25R, 25G, 25B is observed through the first panel 10, so that the conductive material constituting the address electrodes 22 may be transparent or opaque, but the conductive material constituting the discharge-sustaining electrodes 12 must necessarily be transparent. The terms transparent and opaque are based on the light transmission properties of the conductive material at the light emission wavelength (visible light region) peculiar to the material of the phosphor layer. Namely, the conductive material constituting the discharge-sustaining electrodes or the address electrodes can be said to be transparent if it is transparent to the light emitted from the phosphor layer.

As an opaque conductive material, materials such as Ni, Al, Au, Ag, Pd/Ag, Cr, Ta, Cu; Ba, LaB₆, Ca_{0.2}La_{0.8}CrO₃ and the like can be used singly or in appropriate combination. As a transparent conductive material, there may be mentioned ITO (indium tin oxide) and SnO₂. The discharge-sustaining electrodes 12 or the address electrodes 22 can be formed by a sputtering method, a vapor deposition method, a screen printing method, a sandblasting method, a plating method, a lift-off method or the like. The electrode width of the discharge-sustaining electrodes 12 is not particularly limited, and may be about 200 to 400 μm. The distance between the pair of the discharge-sustaining electrodes 12 is not particularly limited, and is preferably about 5 to 150 μm. The width of the address electrodes 22 is, for example, about 50 to 100 μm.

The bus electrode 13, typically, can be included of a metallic material, for example, a single-layer metallic film of Ag, Au, Al, Ni, Cu, Mo, Cr or the like, or a laminated film of Cr/Cu/Cr or the like. The bus electrode 13 formed of such a metallic material, in the reflection-type plasma display device, might reduce the transmission light amount of the visible light radiated from the phosphor layer and transmitted through the first substrate 11 and might thereby lower the luminance of the display screen, so that it is preferable that the electrode width of the bus electrode 13 is as small as possible within the range where an electrical resistance required of the discharge-sustaining electrodes as a whole can be obtained. In concrete, the electrode width of the bus electrode 13 is smaller than the electrode width of the discharge-sustaining electrodes 12, and is, for example, about 30 to 200 μm. The bus electrode 13 can be formed by a sputtering method, a vapor deposition method, a screen printing method, a sandblasting method, a plating method, a lift-off method or the like.

The dielectric layer 14 formed on the surfaces of the discharge-sustaining electrodes 12 is preferably formed by, for example, an electron beam vapor deposition method, a sputtering method, a vapor deposition method, a screen printing method or the like. By providing the dielectric layer 14, it is possible to prevent ions or electrons generated in the discharge spaces 4 from making direct contact with the discharge-sustaining electrodes 12. As a result, wearing of the discharge-sustaining electrodes 12 can be prevented. The dielectric layer 14 has the function of accumulating the wall charges generated in address periods, the function as a resistor for restricting an excessive discharge current, and a memory function for maintaining the discharge condition. The dielectric layer 14 can typically be included of a low melting point glass, and may also be formed by use of other dielectric.

The protective layer 15 provided on the surface of the dielectric layer 14 on the discharge space side displays the effect of preventing the direct contact of ions and electrons with the discharge-sustaining electrodes 12. As a result, wearing of the discharge-sustaining electrodes 12 can be effectively prevented. In addition, the protective layer 15 also has the function of emitting secondary electrons necessary for discharge. As examples of the material for constituting the protective layer 15, there may be mentioned magnesium oxide (MgO), magnesium fluoride (MgF₂) and calcium fluoride (CaF₂). Among others, magnesium oxide is a preferable material having the characteristic features that it is chemically stable, is low in sputtering ratio, is high in light transmittance at the light emission wavelengths of the phosphor layers, is low in discharge start voltage, and so on. The protective layer 15 may have a laminated film structure composed of at least two materials selected from the group consisting of the above-mentioned materials.

As examples of a material for constituting the first substrate 11 and the second substrate 21, there may be mentioned high strain point glass, soda glass (Na₂O.CaO.SiO₂), borosilicate glass (Na₂O.B₂O₃.SiO₂), forsterite (2MgO.SiO₂), and lead glass (Na₂O.PbO.SiO₂) The materials constituting the first substrate 11 and the second substrate 21 may be the same or different.

The phosphor layers 25R, 25G, 25B are each composed, for example, of a phosphor layer material selected from the group consisting of phosphor layer materials capable of emitting light in red, phosphor layer materials capable of emitting light in green, and phosphor layer materials capable of emitting light in blue, and are provided on the upper side of the address electrodes 22. In the case where the plasma display device is for color display, in concrete, for example, the phosphor layer composed of a phosphor layer material capable of emitting light in red (red phosphor layer 25R) is provided on the upper side of one address electrode 22, the phosphor layer composed of a phosphor layer material capable of emitting light in green (green phosphor layer 25G) is provided on the upper side of another address electrode 22, the phosphor layer composed of a phosphor layer material capable of emitting light in blue (blue phosphor layer 25B) is provided on the upper side of a further address electrode 22, and these phosphor layers for emitting light in three primary colors form one set and are provided in a predetermined order. As mentioned above, the region where the one pair of the discharge-sustaining electrodes 12 and one set of the phosphor layers 25R, 25G, 25B for emitting light in three primary colors overlap with each other corresponds to one pixel. The red phosphor layer, the green phosphor layer and the blue phosphor layer may be provided in a stripe pattern or in a lattice pattern.

As phosphor layer materials for constituting the phosphor layers 25R, 25G, 25B, those phosphor layer materials which are high in quantum efficiency and low in saturation to vacuum ultraviolet rays can be appropriately selected from known phosphor layer materials and used. In the case of presuming a color display, it is preferable to combine phosphor layer materials such that the color purity is close to the three primary colors as specified in NTSC, a white balance can be obtained when the three primary colors are mixed, the afterglow time is short, and the afterglow times of the three primary colors are substantially equal. It is known that since N₂ is used as the plasma gas sealed in the discharge spaces 4 in the present embodiment, the vacuum ultraviolet ray emission region is different from the light emission in the case of using Ne—Xe. Accordingly, in the present embodiment, Y₂O₂S;Eu may be mentioned as an example of the phosphor layer material for emitting light in red upon irradiation with vacuum ultraviolet rays, ZnS;Cu may be mentioned as an example of the phosphor layer material for emitting light in green, and ZnS;Ag may be mentioned as an example of the phosphor layer material for emitting light in blue upon irradiation with vacuum ultraviolet rays.

As a method of forming the phosphor layers 25R, 25G, 25B, there may be mentioned a thick film printing method, a method of spraying particles of the phosphor layers, a method of preliminarily adhering a sticky substance to planned portions for formation of the phosphor layers and then adhering the particles of the phosphor layers to the sticky substance, a method of using photosensitive pastes of the phosphor layers and patterning the phosphor layers by exposure to light and development, and a method of forming each of the phosphor layers on the entire surface and thereafter removing unrequired portions by sandblasting.

The phosphor layers 25R, 25G, 25B may be provided directly on the address electrodes 22, and may be provided ranging on the address electrodes 22 and on side wall surfaces of the partition walls 24. Or, the phosphor layers 25R, 25G, 25B may be provided on the dielectric film provided on the address electrodes 22, and may be provided ranging on the dielectric film on the address electrodes 22 and on the side wall surfaces of the partition walls 24. Further, the phosphor layers 25R, 25G, 25B may be provided only on the side wall surfaces of the partition walls 24. As an example of the material for constituting the dielectric film, there may be mentioned low melting point glass and Sio₂.

As has been described above, the second substrate 21 is provided with the partition walls 24 (ribs) extending in parallel with the address electrodes 22. The partition walls (ribs) 24 may have a meander structure. Where the dielectric layer is provided on the second substrate 21 and the address electrodes 22, the partition walls 24 may in some cases be provided on the dielectric layer. As a material for constituting the partition walls 24, known insulating materials may be used; for example, a material composed of a low melting point glass admixed with a metallic oxide such as alumina which is widely used can be used. The partition walls 24 has, for example, a width of about 50 μm and a height of about 100 to 150 μm. The pitch interval of the partition walls 24 is, for example, about 100 to 400 μm.

As an example of the method of forming the partition walls 24, there may be mentioned a screen printing method, a sandblasting method, a dry film method and a photosensitivity method. The dry film method is a method including the steps of laminating a photosensitive film on the substrate, removing the photosensitive film at planned partition wall forming areas by exposure to light and development, embedding a partition wall forming material into opening portions generated by the removal, and baking the partition wall forming material. The photosensitive film is burned and removed by the baking, leaving the partition wall forming material embedded in the opening portions, to be the partition walls 24. The photosensitivity method is a method including the steps of providing a photosensitive partition wall forming material layer on the substrate, patterning the material layer by exposure to light and development, and baking the material layer. A so-called black matrix may be formed by blackening the partition walls 24, whereby enhancement of the contrast of the display screen can be contrived. As an example of the method of blackening the partition walls 24, there may be mentioned a method of forming the partition walls by use of a color resist material colored in black.

One pair of the partition walls 24, and the phosphor layers 25R, 25G, 25B, the address electrodes 22 and the discharge-sustaining electrodes 12 occupying the region surrounded by the pair of partition walls 24 constitute one discharge cell. The discharge gas consisting of a mixture gas is sealed in the inside of the discharge cell, more in concrete, in the inside of the discharge space surrounded by the partition walls, and the phosphor layers 25R, 25G, 25B emit light upon being irradiated with ultraviolet rays generated by an AC glow discharge generated in the discharge gas in the discharge space 4.

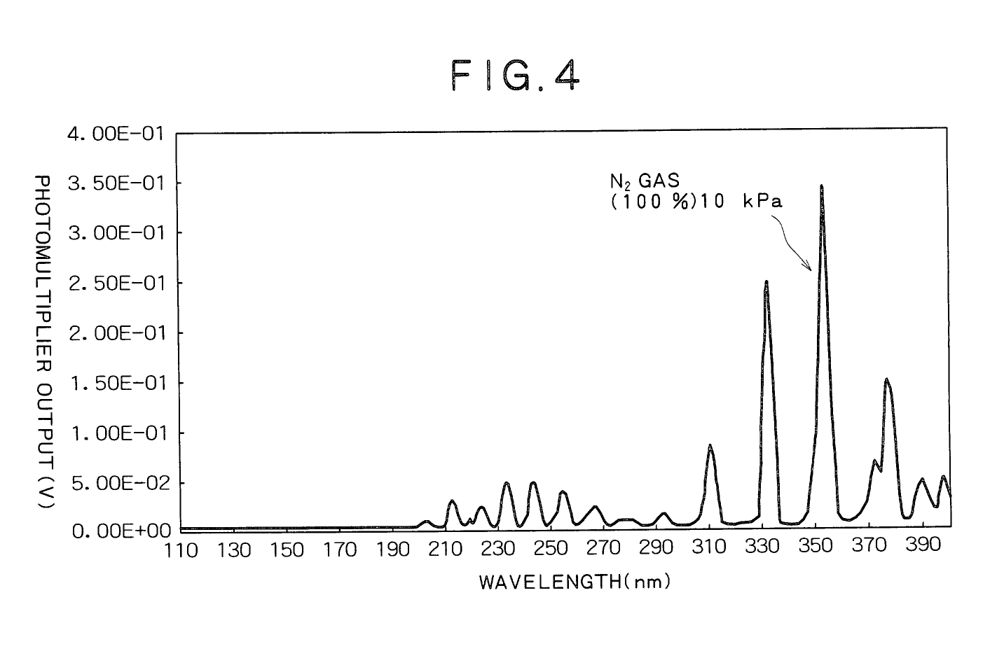

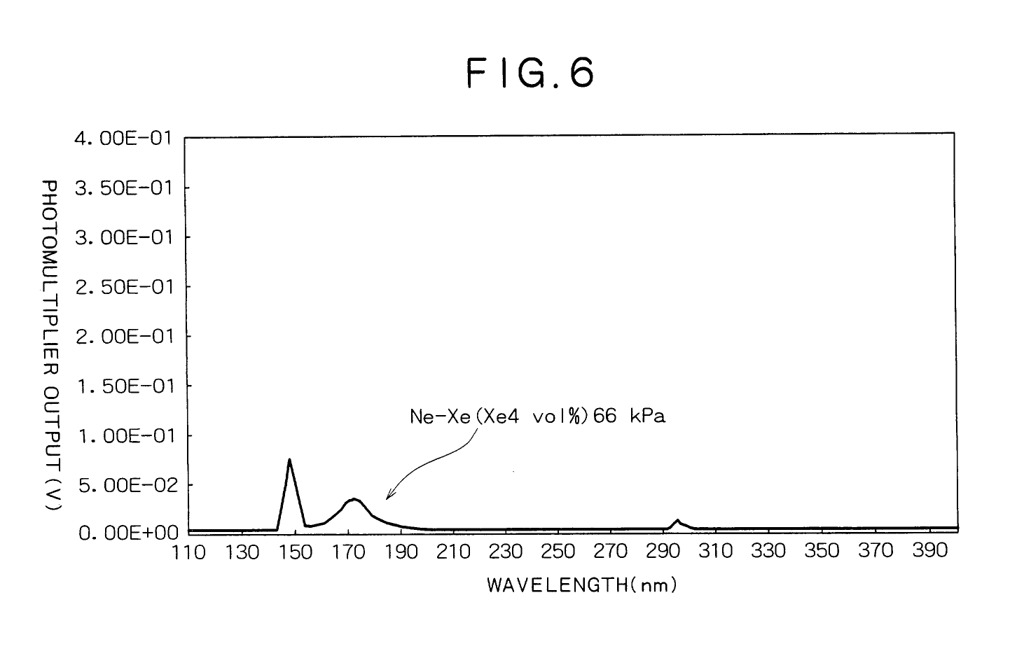

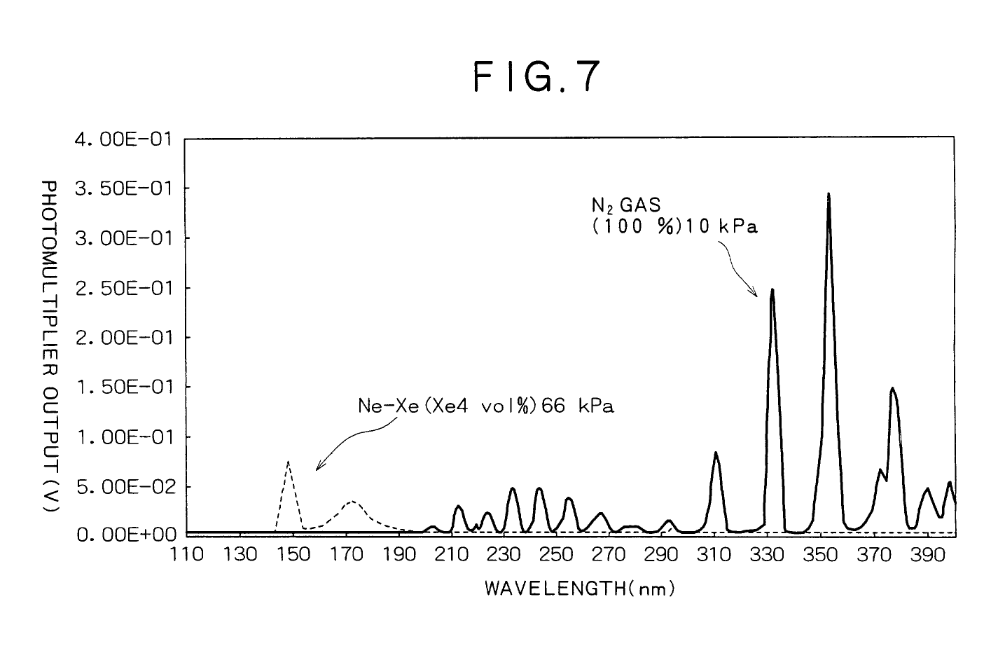

In the plasma display device 2 according to the present embodiment, a nitrogen gas having a purity of substantially 100% is sealed in the discharge spaces 4. The gas pressure of the nitrogen gas and the discharge voltage are in the relationship shown in FIG. 2. An emission spectrum in the case of sealing the nitrogen gas with 100% purity in the discharge spaces at 10 kPa is shown in FIG. 4. In addition, an emission spectrum in the case of sealing an Ne—Xe mixture gas (Xe: 4 vol %) in the discharge spaces at 66 kPa is shown in FIG. 6. Further, a graph obtained by combining the results of FIG. 4 with the results of FIG. 6 is shown in FIG. 7.

As shown in FIG. 7, the intensity of the emission spectrum of the nitrogen gas with 100% purity is remarkably higher, as compared with the emission spectrum of the Ne—Xe mixture gas (Xe: 4 vol %) according to the related art. Further, the sealed-in gas pressure can be set to be low. In addition, as shown in FIG. 2, the discharge voltage is not so high. Therefore, in the plasma display device 2 according to the present embodiment, it can be expected that a high luminance can be obtained even at a low discharge gas pressure. In addition, since the sealed-in gas pressure can be set to be comparatively low, the reliability of adhesion between the panels is enhanced, and, as a result, the reliability of the device is enhanced. Furthermore, since the discharge gas does not contain neon gas in the plasma display device 2 according to the present embodiment, the situation where the image display in the plasma display device has a tone centralized in orange color is obviated, and a high contrast can therefore be achieved.

In the present embodiment, as shown in FIGS. 4 and 7, the peaks of the emission spectrum of the discharge gas exist in a wavelength region of 200 to 400 nm, and, therefore, fluorescent materials capable of emitting light upon receiving ultraviolet rays in the wavelength region of 200 to 400 nm are used for forming the phosphor layers 25R, 25G, 25B.

[Second Embodiment]

In a plasma display device 2 according to the present embodiment, the discharge gas sealed in the plasma discharge spaces 4 where discharge is performed includes a first gas consisting of nitrogen gas, and a second gas containing at least one gas selected from the group consisting of xenon gas, krypton gas, neon gas, helium gas and argon gas. The second gas is preferably the xenon gas. Other points of constitution are the same as those of the plasma display device 2 according to the first embodiment.

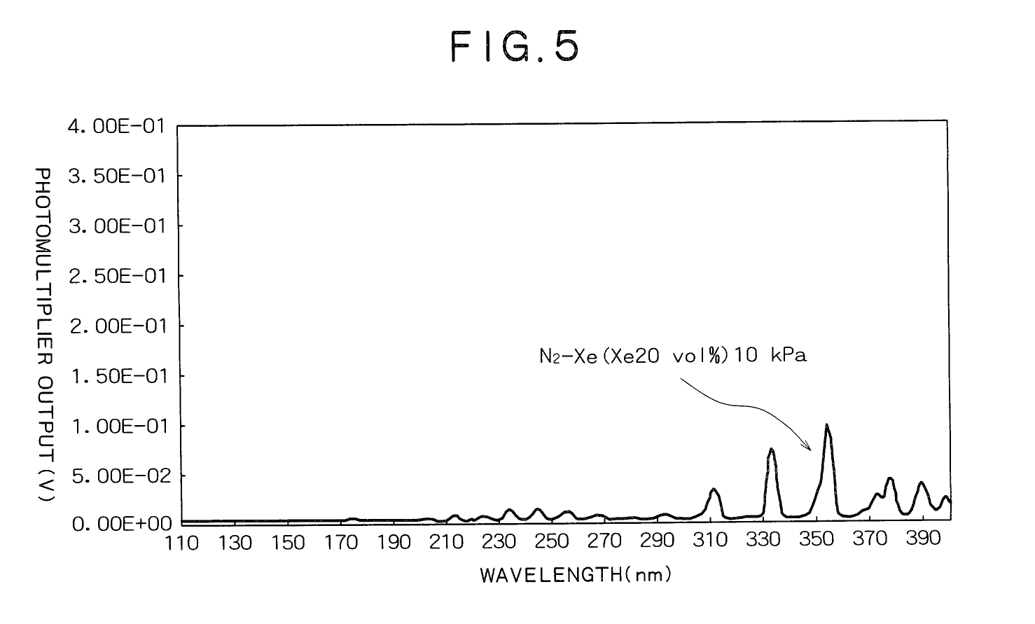

An emission spectrum in the case of sealing an N₂—Xe mixture gas (Xe: 20 vol %) in the discharge spaces at 10 kPa is shown in FIG. 5.

As shown in FIG. 5, the intensity of the emission spectrum of the N₂—Xe mixture gas is higher, as compared with the emission spectrum of the Ne—Xe mixture gas (Xe: 4 vol %) according to the related art. Besides, the sealed-in gas pressure can be set to be low. In addition, the relationship between the gas pressure of the N₂—Xe mixture gas and the discharge voltage has the same tendency as that shown in FIG. 2, and the discharge voltage is not so high. Therefore, in the plasma display device 2 according to the present embodiment, it can be expected that a high luminance can be obtained even at a low discharge gas pressure. In addition, since the sealed-in gas pressure can be set to be comparatively low, the reliability of adhesion between the panels is enhanced, and, as a result, the reliability of the device is enhanced. Furthermore, since the discharge gas does not contain neon gas in the plasma display device 2 according to the present embodiment, the situation where the image display in the plasma display device has a tone centralized in orange color is obviated, and a high contrast can therefore be achieved.

In the present embodiment, as shown in FIG. 5, the peaks of the emission spectrum of the discharge gas exist in a wavelength region of 200 to 400 nm, and, therefore, fluorescent materials capable of emitting light upon receiving ultraviolet rays in the wavelength region of 200 to 400 nm are used for forming the phosphor layers 25R, 25G, 25B.

[Other Embodiments]

The present invention is not limited to or by the above-described embodiments, and various modifications are possible within the scope of the present invention.

For example, in the present invention, the concrete structure of the plasma display device is not limited to the embodiment shown in FIG. 1, and may be other structure. For example, while the so-called three electrode type plasma display device has been shown as an example in the embodiment shown in FIG. 1, the plasma display device according to the present invention may be a so-called two electrode type plasma display device. In that case, one of a pair of discharge-sustaining electrodes is provided on the first substrate, and the other is provided on the second substrate. In addition, the projection image of one of the discharge-sustaining electrodes extends in a first direction, whereas the projection image of the other of the discharge-sustaining electrodes extends in a second direction different from the first direction (preferably, substantially orthogonal to the first direction), and the pair of the discharge-sustaining electrodes are oppositely disposed to face each other. In the two electrode type plasma display device, the expression “address electrode” in the description of the above embodiments may be read as “the other discharge-sustaining electrode”, as required.

Further, while the plasma display device in the above-described embodiments is the so-called reflection type plasma display device in which the first panel 10 is on the display panel side, the plasma display device according to the present invention may be a so-called transmission type plasma display device. In the transmission type plasma display device, the light emission from the phosphor layers is observed through the second panel 20; therefore, though the conductive material constituting the discharge-sustaining electrodes may be transparent or opaque, the address electrodes 22 must necessarily be transparent because the address electrodes 22 are provided on the second substrate 21.

### [EXAMPLES]

Now, the present invention will be further described below based on detailed examples, but the present invention is not limited to or by the examples.

A three electrode type plasma display device having the structure shown in FIG. 1 was produced by the method described below.

When N₂ gas was sealed in the discharge spaces 4 of the present device and discharge was performed, it was confirmed that the most stable discharge occurs at a gas pressure of 10 kPa, as shown in FIG. 2. The process of fabricating the present device will be described below.

A first panel 10 was produced by the following method. First, an ITO layer was formed by, for example, a sputtering method on a first substrate 11 composed of high strain point glass or soda glass, and the ITO layer was patterned into stripes by photolithographic technique and etching technique, to form a plurality of pairs of discharge-sustaining electrodes 12. The discharge-sustaining electrodes 12 extend in a first direction.

Next, an aluminum film was formed on the entire inside surface of the first substrate 11 by, for example, a vapor deposition method, and the aluminum film was patterned by photolithographic technique and etching technique, to form a bus electrode 13 along an edge portion of each of the discharge-sustaining electrodes 12. Subsequently, a dielectric layer 14 consisting of SiO₂ was formed on the entire inside surface of the first substrate 11 provided with the bus electrodes 13, and a protective layer 15 consisting of magnesium oxide (MgO) with a thickness of 0.6 μm was formed thereon by an electron beam vapor deposition method. By these steps, the first panel 10 was completed.

In addition, a second panel 20 was produced by the following method. First, a silver paste was printed in stripes by, for example, a screen printing method on a second substrate 21 composed of high strain point glass or soda glass, and baking was conducted, to form address electrodes 22. The address electrodes 22 extend in a second direction orthogonal to the first direction. Next, a low melting point glass paste layer was formed on the entire surface by a screen printing method. The low melting point glass paste layer was baked, to form a dielectric film. Thereafter, a low melting point glass paste was printed by, for example, a screen printing method on the dielectric film on the upper side of regions between the adjacent address electrodes 22, and baking was conducted, to form partition walls 24. Next, phosphor layer slurries for three primary colors were sequentially printed, and baking was conducted, to form phosphor layers 25R, 25G, 25B ranging on the dielectric film between the partition walls 24 and on side wall surfaces of the partition walls 24. The phosphor layer materials were selected according to the ultraviolet ray emission wavelength of the N₂ gas. Namely, Y₂O₂S;Eu was used as a phosphor layer material for emitting red light upon irradiation with vacuum ultraviolet rays, ZnS;Cu was used as a phosphor layer material for emitting green light, and ZnS;Ag was used as a phosphor layer material for emitting blue light upon irradiation with vacuum ultraviolet rays. By these steps, the second panel 20 was completed.

Next, the plasma display device was assembled. Namely, first, a seal layer was formed on a peripheral portion of the second panel 20 by, for example, screen printing. Next, the first panel 10 and the second panel 20 were adhered to each other, and baking was conducted to harden the seal layer. Thereafter, the spaces formed between the first panel 10 and the second panel 20 were evacuated, a discharge gas was charged into the spaces, and the spaces were sealed off, to complete the plasma display device 2.

One example of an AC glow discharge operation of the plasma display device constituted as above will be described. First, for example, a panel voltage higher than a discharge start voltage Vbd is impressed for a short period on all the discharge-sustaining electrodes 12 on one side. By this, glow discharge is generated, whereby wall charges are generated due to dielectric polarization on the surfaces of the dielectric layer 14 in the vicinity of the discharge-sustaining electrodes on one side, and the wall charges are accumulated, resulting in that the apparent discharge start voltage is lowered. Thereafter, while impressing a voltage on the address electrodes 22, a voltage is impressed on the discharge-sustaining electrodes 12 on one side contained in the discharge cells for non-display, whereby glow discharge is generated between the address electrode 22 and the discharge-sustaining electrode 12 on one side, and the accumulated wall charges are eliminated. This elimination discharge is sequentially performed at each of the address electrodes 22. On the other hand, no voltage is impressed on the discharge-sustaining electrodes on one side contained in the discharge cells for display. By this, the accumulation of the wall charges is maintained. Thereafter, a predetermined pulse voltage is impressed between all pairs of the discharge-sustaining electrodes 12, whereby glow discharge is started between the pair of discharge-sustaining electrodes 12 in each of the cells in which the wall charges have been accumulated. As a result, in the discharge cells, the phosphor layers excited by irradiation with vacuum ultraviolet rays generated by the glow discharge in the discharge gas in the discharge spaces emit light in intrinsic colors according to the kinds of the phosphor layer materials The phases of the discharge-sustaining voltages impressed on the discharge-sustaining electrodes on one side and on the discharge-sustaining electrodes on the other side are staggered from each other by one half period, and the polarity of the electrodes is reversed according to the frequency of the AC.

### [Example 1]

By using the display device shown in FIG. 1, the discharge voltage in the case of using N₂ as the plasma discharge gas sealed in the discharge spaces was measured.

In order to change the sealed-in gas pressure, in the present measurement, the region between evacuation chips was not completely sealed off, the inside of the panels was evacuated, then the nitrogen gas was sealed in, and measurement was conducted. The gas pressure was varied from 5 kPa to 25 kPa, and the discharge voltage for each value of the gas pressure was measured, the results being shown in FIG. 2.

As a result, the discharge voltage showed the lowest value at a gas pressure of 10 kPa, and stable discharge could be obtained. In the present measurement, the temperature at the time of evacuation was low and the evacuation time was not sufficient, as compared with the case of an ordinary panel completely sealed off, so that the absolute values of the discharge voltage were presented as reference values.

### [Example 2]

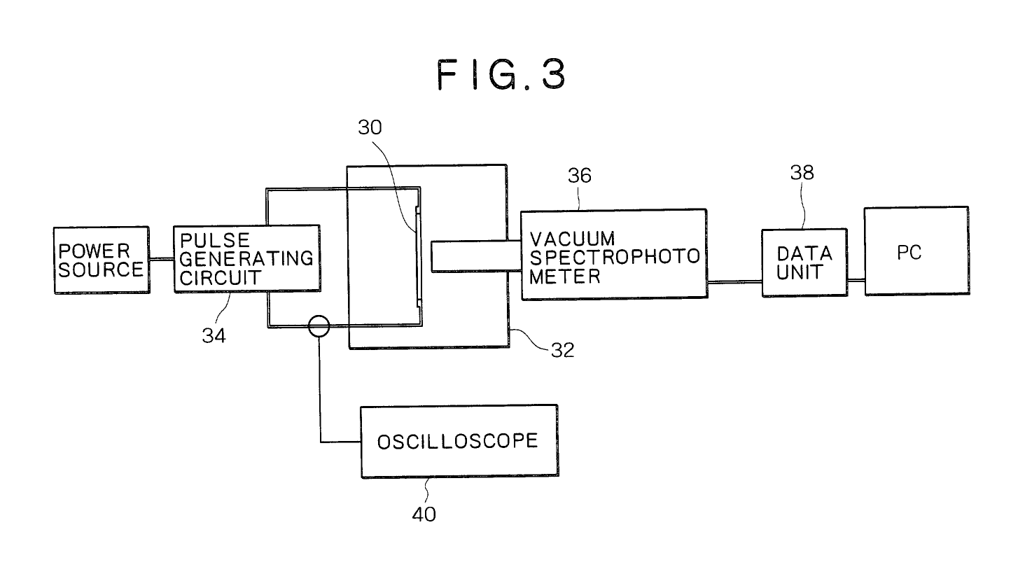

A general view of an emission spectrum intensity measuring instrument is shown in FIG. 3. The emission spectrum intensity measuring instrument has a construction in which a measurement sample 30 is placed in a gas chamber 32, discharge is effected by impressing a pulse by a pulse generating circuit 34 while observing on an oscilloscope 40, the emission spectrum is measured on a vacuum spectrophotometer 36, and data is processed by a data unit 38.

In the present example, as the measurement sample 30, only the first panel 10 in FIG. 1 was used, N₂ gas was sealed in the gas chamber at a gas pressure of 10 kPa, and experiments were conducted. The measurement wavelength was from 110 nm to 400 nm, and representation was conducted by taking the photomultiplier output for each value of wavelength on the axis of ordinates.

FIG. 4 shows the emission spectrum in the case where N₂ gas with 100% purity was sealed in the chamber at 10 kPa.

From this graph, it is seen that a point of a high emission spectrum intensity is present in the vicinity of 350 nm.

### [Example 3]

FIG. 5 shows the emission spectrum intensity of a mixture gas containing nitrogen gas as a first gas and xenon gas as a second gas. The gas had the composition of N₂-Xe (Xe: 20 vol %) and a gas pressure of 10 kPa. It can be said that the spectral characteristics are the same as in the case of N₂ gas, although the photomultiplier output is different from that in the case of N₂ gas.

### [Comparative Example 1]

For the purpose of comparison with a conventional gas, emission spectrum of an Ne—Xe mixture gas was measured. The results are shown in FIG. 6.

The gas composition used here was Ne—Xe (Xe: 4 vol %), and the sealed-in pressure was 66 kPa, which are the gas composition and sealed-in pressure generally used in a PDP. In the emission spectrum measurement for the mixture gas, two large peaks were observed, centered at a wavelength of 147 nm corresponding to a resonance line and at a wavelength of 172 nm corresponding to a molecular line. These are ultraviolet emission wavelengths contributing to major light emission in a PDP, ordinarily.

A graph obtained by combining the emission spectrum of Ne—Xe and the emission spectrum of N₂ is shown in FIG. 7. Though the respective emission regions are different, it is seen that the emission intensity in the case of N₂ is high.

### [Comparative Example 2]

Plasma display devices were assembled in the same manner as in Example 1 except for using those phosphor layer materials which are generally used, for example, (Y₂O₃:Eu), (YBO₃:Eu), (YVO₄:Eu), (Y₀ ₉₆P_{0.60}V_{0.40}O₄:Eu_{0.04}) [(Y,Gd)BO₃:Eu], (GdBO₃:Eu), (ScBO₃:Eu) or (3.5 MgO.0.5 MgF₂.GeO₂:Mn) as a phosphor layer material for emitting red light, (ZnSiO₂:Mn), (BaAl₁₂O₁₉:Mn) (BaMg₂Al₁₆O₂₇:Mn), (MgGa₂O₄:Mn), (YBO₃:Tb), (LuBO₃:Tb) or (Sr₄Si₃O₈Cl₄:Eu) as a phosphor layer material for emitting green light, and (Y₂SiO₅:Ce), (CaWO₄:Pb), CaWO₄, YP_{0.85}V_{0.15}O₄, (BaMgAl₁₄O₂₃:Eu), (Sr₂P₂O₇:Eu) or (Sr₂P₂O₇:Sn) as a phosphor layer material for emitting blue light. By using the plasma display devices, measurement of emission intensity was conducted, but good emission intensity was not obtained.

Namely, it was confirmed that, as shown in Example 1, it is preferable to use Y₂O₂S;Eu as a phosphor layer material for emitting red color upon irradiation with vacuum ultraviolet rays, ZnS;Cu as a phosphor layer material for emitting green light, and ZnS;Ag as a phosphor layer material for emitting blue light.

While preferred embodiments of the present invention have been described using specific terms, such description is for illustrative purposes only, and it is to be understood that changes and variations may be made without departing from the spirit or scope of the following claims.

What is claimed is:

1. A plasma display device wherein a discharge gas sealed in plasma discharge spaces where discharge is performed is substantially only nitrogen.

2. An alternating current driving type plasma display device according to claim 1, comprising at least a pair of discharge-sustaining electrodes.

3. A plasma display device wherein a discharge gas sealed in plasma discharge spaces where discharge is performed comprises a first gas comprised of nitrogen gas, and a second gas containing at least one gas selected from the group consisting of xenon gas, krypton gas, neon gas, helium gas and argon gas.

4. An alternating current driving type plasma display device according to claim 3, comprising at least a pair of discharge-sustaining electrodes.

5. A plasma display device wherein a discharge gas sealed in plasma discharge spaces where discharge is performed comprises a first gas comprised of nitrogen gas, and a second gas comprised of xenon gas.

6. An alternating current driving type plasma display device according to claim 5, comprising at least a pair of discharge-sustaining electrodes.

7. A plasma display device wherein a discharge gas sealed in plasma discharge spaces where discharge is performed comprises a first gas comprised of nitrogen gas, and a second gas containing at least two gases selected from the group consisting of xenon gas, krypton gas, neon gas, helium gas and argon gas.

8. An alternating current driving type plasma display device according to claim 7, comprising at least a pair of discharge-sustaining electrodes.

9. A plasma display device wherein a discharge gas sealed in plasma discharge spaces where discharge is performed contains a gas having a peak of emission spectrum intensity in a wavelength region of 200 to 400 nm.

10. An alternating current driving type plasma display device according to claim 9, comprising at least a pair of discharge-sustaining electrodes.

11. A plasma display device according to claim 9, wherein a phosphor layer for emitting light upon receiving ultraviolet rays in a wavelength region of 200 to 400 nm is provided in said plasma discharge spaces.

12. An alternating current driving type plasma display device according to claim 11, comprising at least a pair of discharge-sustaining electrodes.
